(19) United States
(12) Patent Application Publication
(10) Pub. No.: US 2023/0083786 A1
(43) Pub. Date: Mar. 16, 2023

(54) SERVICE TAKE-OUT COOKING SYSTEM AND METHOD

(71) Applicants: Daniel Brawer, Bellevue, WA (US); Norman Wu, Bellevue, WA (US)

(72) Inventors: Daniel Brawer, Bellevue, WA (US); Norman Wu, Bellevue, WA (US)

(21) Appl. No.: 17/989,681

(22) Filed: Nov. 18, 2022

(51) Int. Cl. B65D 81/34; B65D 25/04; A47J 37/07

(52) U.S. Cl. CPC B65D 81/3484; B65D 81/3476; B65D 25/04; A47J 37/0763

(57) ABSTRACT

Presented is a self-service take-out cooking box for customized heating of the food item(s). The self-service take-out cooking box includes a base and multiple sidewalls extending from the base. The box further includes a heating module and food container(s) to receive at least one food item therein. The heating module of the self-service take-out cooking box includes a cooking grate configured to provide a cooking platform for the one food item. A cooking fuel receiving chamber of the heating module is configured to receive at least one cooking fuel. The configuration of the self-service take-out cooking box allows the customer to heat the food at their own location.

### FIELD OF INVENTION

The present invention generally relates to self-service tableware and more particularly, it pertains to a take-out cooking box that comprises a heating arrangement therein.

### BACKGROUND

In modern times, people are ordering various food from various restaurants and various other food outlets such as but not limited to: pizza, pasta, curry, fried rice, noodles, meat slices, fish, and so on using multiple food ordering platforms such as mobile applications, websites, telephone calls and so on. Further, customers sometimes go to the restaurant and various other food outlets, and then, they place orders of the food and then take away ordered food for later consumption.

After placing an order for the food, generally food is delivered in a disposable food container or a food packaging tray. The disposable food container or a food packaging tray is made up of heat-blocking material such that the food inside the disposable food container or a food packaging tray remains heated for extended periods of time.

Often, food from the restaurant to the customer is delivered by a delivery personnel using various means of transport. Due to various factors such as but not limited to: traffic jams in road to delivery location, cold/rainy weather, and rush/high demand hours, the food delivery time is extended which could lead to food getting cold. Further, sometimes, restaurant worker packages cold food in the disposable food container or a food packaging tray for collection by the delivery personnel due to various factors such as: low temperature improper cooking, peak hour demand, human error and so on. Thus, the customer gets cold food (low-temperature food) which does not provide satisfaction and/or enjoyment to the customer who is planning to eat the food.

Generally, the cold food is heated by the customer depending on the taste of the customer. However, sometimes, the customer does not have a readily available heating arrangement such as a gas stove, an induction heater, a microwave oven etc. Thus, the customer has to eat cold food (low-temperature food) which does not provide satisfaction and/or enjoyment to the customer.

Further, some customers like to customize (prepare) their food by heating the food (raw food/ready to eat food) according to their own taste and style in their own location i.e at home, office, park, and on. For instance, many customers want to barbecue their food and further add their own spices and oil to make food more delicious. The pre-packaged disposable food container or a food packaging tray provided by the restaurant does not provide the option of customization of the food by heating the food at the customer's location.

Various types of cooking boxes attempting to solve the above problems are known in the prior art. For example, WO2008032135A1 discloses a battery-powered lunch box that includes an electric element extending about a food-receiving dish in the base and an evacuated heat insulating base-chamber surrounding the element, sides, and floor of the dish. A lid includes an evacuated heat insulating lid chamber with a plug portion which projects into the mouth of the dish for closing the dish and reducing heat losses. The configuration of the battery powered lunch box allows food to be heated in places remote from an electricity supply. However, the existing solution related to cooking boxes increases manufacturing complexities and costs related to the cooking boxes.

Thus, the existing prior art(s) do not provide a cost effective, simple, easy to operate and efficient solution and fail to provide a take-out cooking box that comprises a heating arrangement therein. Thus, there is a need for a system and method that allows the customer to heat the food at their own location.

### SUMMARY

Before the present systems and methods are described, it is to be understood that this application is not limited to the particular systems, and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application.

Embodiments of the present invention disclose a self-service take-out cooking box comprising: a base; a plurality of sidewalls extending from the base; a cavity formed in the space between the base and the plurality of sidewalls; a lid cover configured to close the top of cavity of the plurality of sidewalls; wherein the lid cover could be selectively brought in an open position and/or a closed position. The cavity comprises a heating module and at least one food container to receive at least one food item. The heating module comprises a cooking grate configured to provide a cooking platform for at least one food item and a cooking fuel receiving chamber positioned substantially below the cooking grate. The cooking fuel receiving chamber is configured to receive at least one cooking fuel.

In an embodiment, the cavity comprises at least one cooking fuel ignition element.

In an embodiment, the cooking fuel ignition element is selected from group comprising of: a matchstick box, a gas lighter, an oil lighter and an electric lighter.

In an embodiment, the heating module is concealed inside self-service take-out cooking box when the lid cover is in a closed position.

In an embodiment, the cooking grate is detachable to allow placement and/or removal of the cooking fuel in/from the cooking fuel receiving chamber.

In an embodiment, the heating module comprises an insulating element to effectively block heat transfer from the heating module to the food containers.

In an embodiment, the cooking fuel receiving chamber receives cooking fuel selected from the group comprising of: charcoal, coal, Briquette, biomass, wood, kerosene and liquid propane and/or combinations thereof.

Embodiments of the present invention further disclose a self-service take-out cooking box comprising a base and plurality of sidewalls extending from the base, a cavity formed in the space between the base and the plurality of sidewalls. A lid cover is configured to close the top of cavity of the plurality of sidewalls. The lid cover could be selectively brought in either an open position and/or a closed position. The cavity comprises a heating module and at least one food container to receive at least one food item. The heating module comprises a cooking grate configured to provide a cooking platform for at least one food item, and an electric heater positioned substantially below the cooking grate to provide heat to at least one food item.

In an embodiment, the heating module comprises an electrical inlet to receive electric power from the surrounding.

In an embodiment, the heating module comprises at least one battery to act as electrical power source for the electric heater.

In an embodiment, the heating module is concealed inside self-service take-out cooking box when the lid cover is in a closed position.

In an embodiment, the heating module comprises an insulating element to effectively block heat transfer from the heating module to the food containers.

In an embodiment, the cooking grate and the electric heater of the heating module are integrally connected to each other.

Embodiments of the present invention further disclose a meal preparation method that enables a customer to prepare a customized meal comprising the steps of providing a self-service take-out cooking box; wherein the self-service take-out cooking box comprises a heating module and at least one food container; packaging at least one food item in the food containers of the self-service take-out cooking box; transporting the self-service take-out cooking box to the customer; placing of the food items of the food containers onto a cooking grate of the heating module by customer, and customized heating of the food items using the heating module by the customer; thereby preparing a customized meal.

In an embodiment, the food item packaged in the food containers is initially raw uncooked food.

In an embodiment, the food item packaged in the food containers is ready-to-eat meal.

In an embodiment, an additional step of meal preparation method comprises placing at least one cooking fuel inside a cooking fuel receiving chamber of the heating module; and igniting the cooking fuels to produce heat for the food items.

In an embodiment, an additional step of meal preparation method comprises detaching the cooking grate to allow placement and/or removal of the cooking fuel in/from the cooking fuel receiving chamber.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a perspective view of a self-service take-out cooking box when the lid cover is in an open position, according to an embodiment of the present invention.

FIG. 2 illustrates a top view of the self-service take-out cooking box of FIG. 1, wherein lid cover is not shown for simplicity and ease of understanding.

FIG. 3 illustrates a perspective view of a self-service take-out cooking box, according to another embodiment of the present invention.

FIG. 4 illustrates a perspective view of a heating module of the self-service take-out cooking box, according to an embodiment of the present invention.

FIG. 5 illustrates a perspective view of a heating module of FIG. 4, wherein cooking grate is positioned in detached condition.

FIG. 6 illustrates a cross-sectional view of the heating module of FIG. 4.

FIG. 7 illustrates a top view of a self-service take-out cooking box, according to yet another embodiment of the present invention wherein lid cover is not shown for simplicity and ease of understanding.

FIG. 8 illustrates a perspective view of a self-service take-out cooking box when the lid cover is in closed position, according to an embodiment of the present invention.

### DETAILED DESCRIPTION

Some embodiments, illustrating its features, will now be discussed in detail. The words “comprising,” “having,” “containing,” and “including,” And other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” And “the” Include plural references unless the context clearly dictates otherwise. Although any methods and systems similar or equivalent to those described herein can be used in the practice or testing of embodiments, the preferred methods, and systems are now described. The disclosed embodiments are merely exemplary.

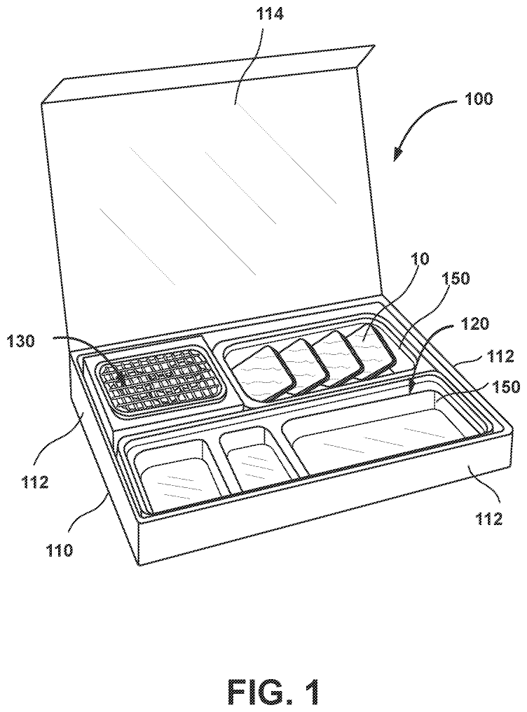

The various features and embodiments of the present invention for a self-service Take-out cooking system and method involving use of the self-service take-out cooking box (100, 200) will now be described in conjunction with the accompanying figures, namely FIGS. 1-8.

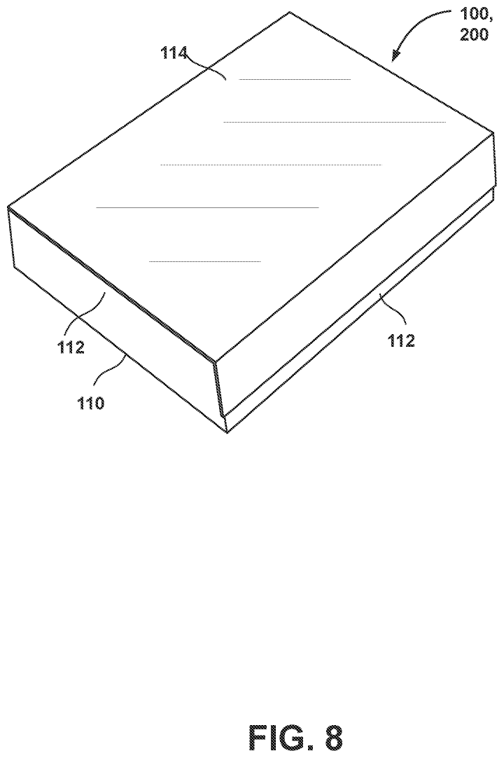

FIG. 1 illustrates a perspective view of a self-service take-out cooking box 100 when a lid cover 114 is in an open position, according to an embodiment of the present invention. The self-service take-out cooking box 100 comprises a base 110, a plurality of sidewalls 112 extending from the base 110. The base 110 and the plurality of sidewalls 112 are interconnected to define a cavity 120. The cavity 120 is formed in the space between the base 110 and the plurality of sidewalls 112. A lid cover 114 is hingedly connected to at least one of the plurality of sidewalls 112 wherein the lid cover 114 can be selectively brought from an open position (FIG. 1) to a closed position (FIG. 8) and vice versa. The lid cover 114 is configured to close the top of cavity 120 of the plurality of sidewalls 112. The lid cover 114 could be selectively brought in an open position (FIG. 1) and/or a closed position (FIG. 8). In an embodiment as shown in FIG. 1, the cavity 120 comprises a plurality of food containers 150 to receive at least one food item 10, and a heating module 130 which will be described in detail in below description.

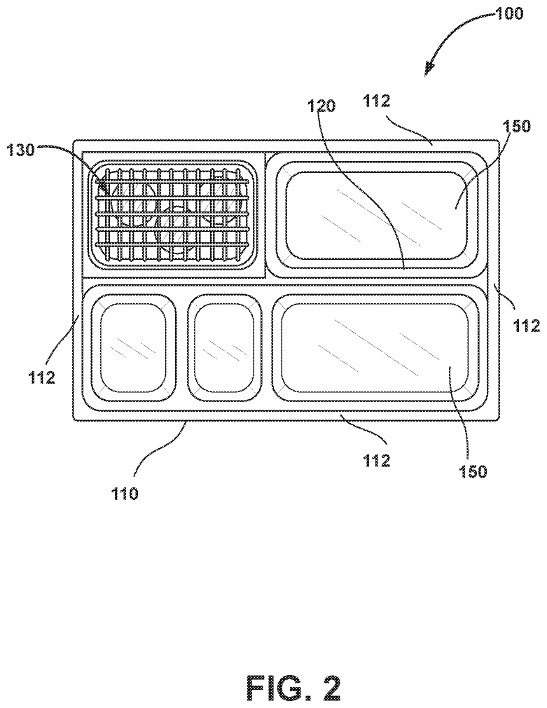

FIG. 2 illustrates a top view of the self-service take-out cooking box 100 of FIG. 1, wherein lid cover 114 is not shown for simplicity and ease of understanding. As shown in FIGS. 1-2, the self-service take-out cooking box 100, in particular base 110, is generally rectangular in shape wherein the number of the plurality of sidewalls 112 is four. However, in various other embodiments (not shown in figures), the self-service take-out cooking box 100, in particular base 110, could have any other shape including but not limited to: triangle, circle, hexagon, pentagon, square, octagon, and so on. Similarly, in various other embodiments (not shown in figures), the number of the plurality of sidewalls 112 could be any arbitrary number, for instance one, two, three, five, six, and so on. It should be understood that for circular self-service take-out cooking box 100, the number of sidewalls is one such that a single sidewall is continuously connected to whole perimeter of the circular base 110.

In another embodiment (not shown in figures), the lid cover 114 is not connected to any of sidewalls 112. The lid cover 114 is completely detached from the plurality of sidewalls 112 when the self-service take-out cooking box 100 is in the open position. To bring the self-service take-out cooking box 100 in the closed position, the lid cover 114 is manually placed on top of the plurality of sidewalls 112 and locked in place and vice versa.

In another embodiment (not shown in figures), the lid cover 114 is made of a tearable material. The tearable material could include but is not limited to: plastic film, aluminium foil, paper, plastic sheet, and so on. The self-service take-out cooking box 100 is initially at closed position such that the lid cover 114 is connected to the sidewalls 112. In the closed position, the lid cover 114 could be glued or tape bonded to the plurality of sidewalls 112. Afterward, the lid cover 114 is manually torn (ripped) to allow access to the contents (food items 10) of the self-service take-out cooking box 100, thereby bringing the self-service take-out cooking box 100 in the open position.

To effectively lock the lid cover 114 with the plurality of sidewalls 112, thereby bringing the self-service take-out cooking box 100 in the closed position, a locking mechanism (not shown in figures) is provided on at least one of the sidewalls 112 and/or lid cover 114. The locking mechanism (not shown in figures) could include any conventional means already known in art and it could include but not be limited to: self-locking flaps, self-locking tabs, velcro lock, magnetic lock, origami, snap fit lock, zipper, paper cutting/folding, adhesives, tapes, heat-sealing and so on.

In various embodiments, the food item 10 placed in food container(s) 150 could be any substance capable of being eaten and/or swallowed and/or providing nutritional support to the consumer/customer. The food item 10 could be in form of solid, liquid, or liquid-solid mixture and the food item 10 could include any edible and/or drinkable product such as but not limited to: pizza, pasta, curry, fried rice, noodles, coffee drink, soup, hamburger, meat, fish, corn, omelette, sauce, ketchup, oils, herbs, spices and so on. Further, the food container(s) 150 could be made of any food grade material such as but not limited to: food grade polyethylene, paper, styrofoam, pulp, polystyrene, wood, eco-friendly alternatives such as biodegradable plastics and so on and could have any shape such as but not limited to: square, rectangle, circle, hexagon, triangle and so on. The food item 10 could be in form of solid, liquid, or liquid-solid mixture and the food item 10 could include but not limited to: pizza, pasta, curry, Fried rice, noodles, coffee drink, soup, hamburger, meat, fish, corn, omelette and so on.

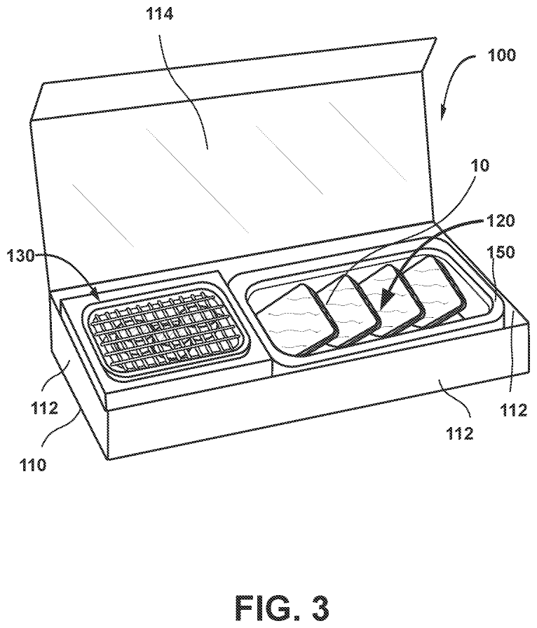

In another embodiment as shown in FIG. 3, the cavity 120 comprises a single food container 150 to receive at least one food item 10, and a heating module 130 which will be described in detail in below description. The cavity 120 and the self-service take-out cooking box 100 is similar to the cavity 120 and the self-service take-out cooking box 100 of FIG. 1 except the difference in number of food containers 150.

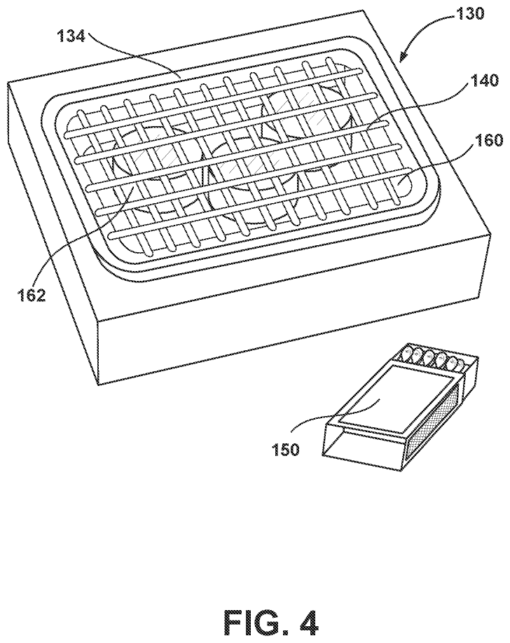

The heating module 130 of the self-service take-out cooking box 100, according to an embodiment of the present invention will now be described with reference to FIGS. 4-6.

As shown in FIG. 4, the heating module 130 comprises a cooking grate 140 configured to provide a cooking platform for at least one food item 10 (FIG. 1). Further, the heating module 130 comprises a cooking fuel receiving chamber 160 positioned substantially below the cooking grate 140. The cooking fuel receiving chamber 160 is configured to receive at least one cooking fuel 162. In an embodiment, a cooking fuel ignition element 150 is provided in the cavity 120 of the self-service take-out cooking box 100 (FIG. 1). In another embodiment, the cooking fuel ignition element 150 is provided in the heating module 130 itself of the self-service take-out cooking box 100. Alternatively, in another embodiment, the cooking fuel ignition element 150 is not provided in the self-service take-out cooking box 100. The heating module 130 comprises an insulating element 134 to effectively block heat transfer from the heating module 130 to the food container(s) 150 (FIG. 1). The cooking grate 140 is detachably positioned on the insulating element 134 to provide a cooking platform for at least one food item 10 (FIG. 1) so a customer can place the food item(s) 10 (FIG. 1) on the top of the cooking grate 140.

In an embodiment, as shown in FIG. 4, the cooking fuel ignition element 150 is a matchstick box having multiple matchsticks. In various other embodiments (not shown in Figures), the cooking fuel ignition element 150 could include any tool capable of producing fire/spark and could include but not be limited to: a gas lighter, an oil lighter and an electric lighter, and so on.

In various embodiments (not shown in Figures), the insulating element 134 could include but not limited to aluminium foil, urethane foam, styrofoam, expanded polystyrene, cotton, food grade polyethylene, or polypropylene, vacuum insulation, tin foil, plastic wrap and so on.

In an embodiment, as shown in FIG. 4, the cooking fuel 162 is a charcoal block. In various embodiments (not shown in Figures), the cooking fuel receiving chamber 160 receives cooking fuel 162 selected from the group comprising of briquette, coal, biomass, wood, kerosene, and liquid propane and/or combinations thereof.

In an embodiment, as shown in FIG. 4, the cooking grate 140 is a mesh-like grill on which the food item (s) 10 is cooked. The cooking grate material could include any material able to support weight of food item(s) 10 and capable of handling high temperature heat. The cooking grate material could include but not limited to: steel, iron, metal alloys and so on.

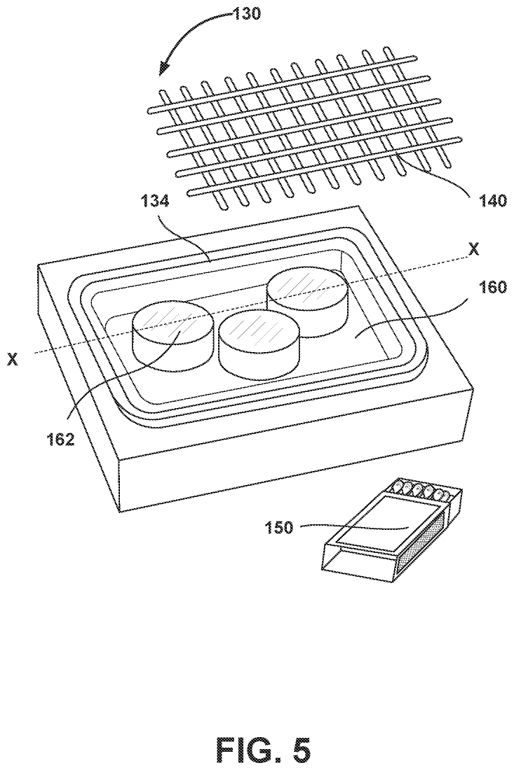

FIG. 5 illustrates a perspective view of a heating module 130 of FIG. 4, wherein cooking grate 140 is positioned in a detached condition. The cooking grate 140 is detachable from the insulating element 134 to allow placement and/or removal of the cooking fuel 162 in/from the cooking fuel receiving chamber 160.

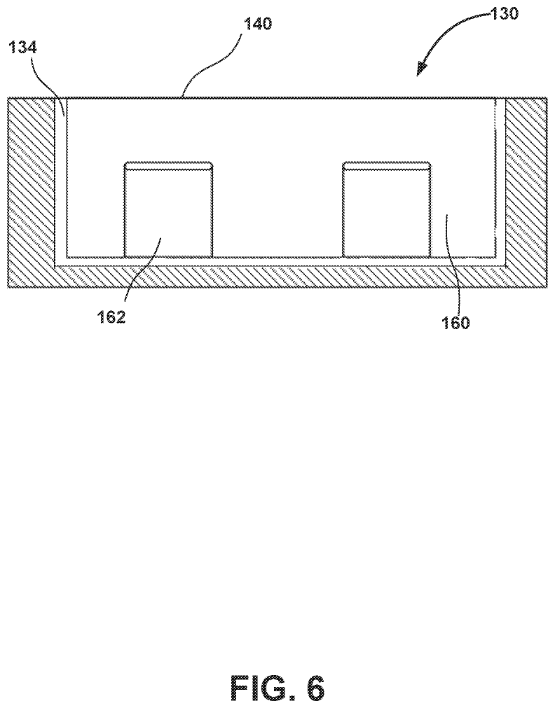

FIG. 6 illustrates a cross-sectional view of the heating module 130 of FIG. 4 taken along lines X-X. As seen in FIG. 6, the cooking fuel receiving chamber 160 is positioned substantially below the cooking grate 140. The cooking fuel receiving chamber 160 is configured to receive at least one cooking fuel 162.

As shown in FIGS. 4-6, the heating module 130 is generally rectangular in shape. However, in various other embodiments (not shown in figures), the heating module 130 could have any other shape including but not limited to: triangle, circle, hexagon, pentagon, square, octagon, and so on.

In an embodiment (not shown in figures), the heating module 130 comprises a storage slot (not shown in figures) to receive the cooking fuel 162 and/or the cooking fuel ignition element 150.

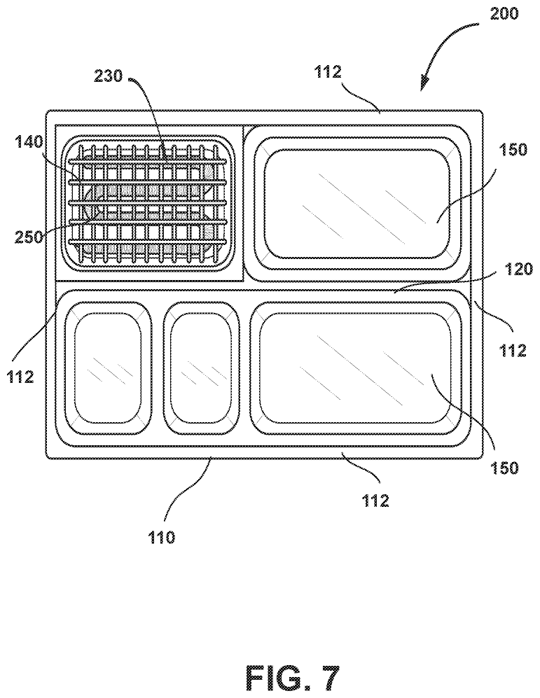

FIG. 7 illustrates a top view of a self-service take-out cooking box 200 according to an embodiment of the present invention wherein the lid cover 114 (FIG. 1) is not shown for simplicity and ease of understanding. The self-service take-out cooking box 200 is pretty similar to the self-service take-out cooking box 100 (FIGS. 1-3) except for the modifications associated with the heating module.

The self-service take-out cooking box 200 comprises a base 110, and a plurality of sidewalls 112 extending from the base 110. A cavity 120 is formed in the space between the base 110 and the plurality of sidewalls 112. A lid cover 114 (FIG. 1) is configured to close the top of cavity 120 of the plurality of sidewalls 112; wherein the lid cover 114 (FIG. 1) could be selectively brought in either an open position and/or a closed position. The cavity 120 comprises a heating module 230 and at least one food container 150 to receive at least one food item 10 (FIG. 1).

As shown in FIG. 7, the heating module 230 comprises a cooking grate 140 configured to provide a cooking platform for at least one food item 10 (FIG. 1), and an electric heater 250 positioned substantially below the cooking grate 140 to provide heat to at least one food item 10 (FIG. 1).

In an embodiment (not shown in figures), the heating module 230 comprises an electrical inlet (not shown in figures) to receive electric power from the surroundings. Further, the heating module 230 could also include electrical components/circuitry (not shown in figures) that are capable of collecting electric power from the electrical inlet (not shown in figures) and transmitting electric power to the electric heater 250 and the electrical components/circuitry (not shown in figures) could include but not limited to: wires, resistors, Printed circuit board, capacitor, transformer, amplifier and so on. Similarly, a trigger switch (not shown in figures) could be provided to start/stop the operation of the electric heater 250.

In another embodiment (not shown in figures), the heating module 230 comprises at least one battery (not shown in figures) to act as electrical power source for the electric heater 250. The battery (not shown in figures) could be rechargeable or for one-time use only. Further, the heating module 230 could also include electrical components/circuitry (not shown in figures) that are capable of collecting electric power from battery(s) (not shown in figures) and transmitting electric power to the electric heater 250 and the electrical components/circuitry could include but not limited to: wires, resistors, Printed circuit boards, capacitors, transformer, amplifier and so on. Similarly, a trigger switch (not shown in the figures) could be provided to start/stop the operation of the electric heater 250.

In another embodiment (not shown in figures), the cooking grate 140 and the electric heater 250 of the heating module 230 are integrally connected to each other during the manufacturing of the heating module 230. This configuration enables a solid and rigid connection between the cooking grate 140 and the electric heater 250 of the heating module 230. In another embodiment (not shown in figures), the cooking grate 140 and the electric heater 250 of the heating module 230 are detachably connected to each other to enable easy cleaning/maintenance of the electric heater 250 and/or cooking grate 140.

In an embodiment, as shown in FIG. 7, the electric heater 250 of the heating module 230 includes a continuous serpentine like filament. In another embodiment (not shown in figures), the electric heater 250 could have multiple filaments. The electric heater 250 could have other filament design and/or shape such as but not limited to: straight filament, circular filament, and so on.

FIG. 8 illustrates a perspective view of a self-service take-out cooking box (100, 200) of FIGS. 1-7 when the lid cover 114 is in closed position, according to an embodiment of the present invention. As seen in FIG. 8, the heating module (130, 230) is concealed inside the self-service take-out cooking box (100, 200) when the lid cover 114 is in a closed position. Thus, the heating module (130, 230) is not visible to the naked eye of any person when the self-service take-out cooking box (100, 200) is in the closed position.

An exemplary meal preparation method that enables a customer to prepare a customized meal will now be described in detail in reference to FIGS. 1-8.

Firstly, at least one food item 10 (FIG. 1) is packaged in the food containers 150 of the self-service take-out cooking box (100, 200) using any conventional means/technique already known in the art. In an embodiment, the food item 10 (FIG. 1) packaged in the food container(s) 150 is initially raw uncooked food. In another embodiment, the food item 10 (FIG. 1) packaged in the food containers 150 is ready-to-eat meal. Afterward, the self-service take-out cooking box (100, 200) is transported to the customer using any conventional transport medium. The customer can themselves carry the self-service take-out cooking box (100, 200) or alternatively, a delivery person can carry the self-service take-out cooking box (100, 200).

Afterwards, the customer opens the lid 114 of the self-service take-out cooking box (100, 200) and then access the food item(s) 10 of the food container(s) 150. Afterwards, the food item(s) 10 of the food containers 150 are placed onto a cooking grate 140 of the heating module (130, 230) by the customer. Depending on the type of heating module 130, the customer proceeds to heat up the food item(s) 10 placed on the cooking grate 140. For instance, for the heating module 230 (FIG. 7), the customer starts operation of the electric heater 250 by using trigger switch (not shown in figures), thereby heating up the food item(s) 10 placed on the cooking grate 140. For the heating module 130 (FIGS. 4-6), the customer can place the cooking fuel 162 in the cooking fuel receiving chamber 160 by detaching and lifting the cooking grate 140. Afterwards, the customer can ignite the cooking fuel 162 placed in the cooking fuel receiving chamber 160 using the cooking fuel ignition element 150 and then re-attach the cooking grate 140 to the remaining of the heating module 130, thereby heating the up the food item(s) 10 placed on the cooking grate 140. Depending on the eating style of the customer, the customer can heat the food item(s) 10 using the heating module 130, thereby preparing a customized meal. In an exemplary embodiment, the customer can barbecue the food item(s) 10 such as but not limited to: meat using the heating module 130. Customer can also apply various sauces, oils and spices to the food item(s) 10 while the food item(s) 10 is being heated on the cooking grate 140.

It should be well understood that the Customer can use tableware including but not limited to: plates, cup, bowl and so on for heating some specific food item(s) 10 placed on the cooking grate 140. For instance, the customer can first place the food item(s) 10 (rice, for instance) in a bowl (not shown in figures) and then the customer can place the bowl (not shown in figures) comprising food item(s) 10 (rice) on the cooking grate 140 for heating purpose. The tableware could be provided in the self-service take-out cooking box (100, 200) itself, or alternatively, the customer can use their tableware already available to them.

It should be understood that the term “customer” is a broad term and could include any person who either wishes to eat food or prepare food/meal for another person at a location different from the restaurant or any food outlet. The customer could include but not limited to: food eater, food ordering personnel, food preparation personnel such as homemaker and so on. The different location could include but not limited to: home, office, park, lecture hall, trekking route, gym and so on. Broadly speaking, the term “customer” could be any person who intends to use the self-service take-out cooking box (100, 200) for customized heating of the food item(s) 10.

The self-service take-out cooking box (100, 200) of the present invention includes various components, parts thereof may be configured in many different shapes, sizes and using different kinds of food-grade materials, including but not limited to metals, plastics, paper, ceramics, wood, composites, polymers, rubber and one should not construed these aspects to be a limiting factor for the invention disclosed herein. The self-service take-out cooking box (100, 200) of the present invention has the potential application to the fields of food customization technology, beverage preparation and customer friendly food preparation.

It should be understood that the various components and assemblies of the various embodiments of the self-service take-out cooking box (100, 200) of the present invention are similar and interchangeable. For instance, a non-limiting example, the terms “food”, “food item(s)” and “meal” are similar in meaning and are interchangeably used to better suit the embodiments of the present invention. It is obvious to the one skilled in the art that the various components and assemblies of the self-service take-out cooking box (100, 200) of one embodiment of the present invention could be considered for other embodiments with little or no variation.

It should be understood according to the preceding description of the present invention that the same is susceptible to changes, modifications and adaptations, and that the said changes, modifications and adaptations fall within scope of the appended claims.

What is claimed is:

1. A self-service take-out cooking box (100), comprising:
a base (110);
a plurality of sidewalls (112) extending from the base (110);
a cavity (120) formed in the space between the base (110) and the plurality of sidewalls (112);
a lid cover (114) configured to close the top of the cavity (120) of the plurality of sidewalls (112); wherein the lid cover (114) could be selectively brought in an open position and/or a closed position;
Wherein the cavity (120) comprises a heating module (130) and at least one food container (150) to receive at least one food item (10);
Wherein the heating module (130) comprises a cooking grate (140) configured to provide a cooking platform for the at least one food item (10) and a cooking fuel receiving chamber (160) positioned substantially below the cooking grate (140); and
Wherein the cooking fuel receiving chamber (160) is configured to receive at least one cooking fuel (162).

2. The self-service take-out cooking box (100) of claim 1, wherein the cavity (120) comprises at least one cooking fuel ignition element (150).

3. The self-service take-out cooking box (100) and/or cooking fuel ignition element (150) of claim 2, wherein the cooking fuel ignition element (150) is selected from a group comprising of: a matchstick box, a gas lighter, an oil lighter and an electric lighter.

4. The self-service take-out cooking box (100) of claim 1, wherein the heating module (130) is concealed inside the self-service take-out cooking box (100) when the lid cover (114) is in a closed position.

5. The self-service take-out cooking box (100) of claim 1, wherein the cooking grate (140) is detachable to allow placement and/or removal of the cooking fuel (162) in/from the cooking fuel receiving chamber (160).

6. The self-service take-out cooking box (100) of claim 1, wherein the heating module (130) comprises an insulating element (134) to effectively block heat transfer from the heating module (130) to the food container(s) (150).

7. The self-service take-out cooking box (100) of claim 1, wherein the cooking fuel receiving chamber (160) receives cooking fuel (162) selected from the group comprising of: charcoal, coal, Briquette, biomass, wood, kerosene and liquid propane and/or combinations thereof.

8. The self-service take-out cooking box (100) of claim 1, wherein the heating module (130) comprises a storage slot to receive the cooking fuel (162) and/or the cooking fuel ignition element (150).

9. A self-service take-out cooking box (200), comprising:
a base (110);
a plurality of sidewalls (112) extending from the base (110);
a cavity (120) formed in the space between the base (110) and the plurality of sidewalls (112);
a lid cover (114) configured to close the top of the cavity (120) of the plurality of sidewalls (112); wherein the lid cover (114) could be selectively brought in either an open position and/or a closed position;
Wherein the cavity (120) comprises a heating module (230) and at least one food container (150) to receive at least one food item (10); and
Wherein the heating module (230) comprises a cooking grate (140) configured to provide a cooking platform for the at least one food item (10), and an electric heater (250) positioned substantially below the cooking grate (140) to provide heat to the at least one food item (10).

10. The self-service take-out cooking box (200) of claim 9, wherein the heating module (230) comprises an electrical inlet to receive electric power from surroundings.

11. The self-service take-out cooking box (200) of claim 9, wherein the heating module (230) comprises at least one battery to act as an electrical power source for the electric heater (250).

12. The self-service take-out cooking box (200) of claim 9, wherein the heating module (230) is concealed inside the self-service take-out cooking box (100) when the lid cover (114) is in a closed position.

13. The self-service take-out cooking box (200) of claim 9, wherein the heating module (230) comprises an insulating element (134) to effectively block heat transfer from the heating module (130) to the food container(s) (150).

14. The self-service take-out cooking box (200) of claim 9, wherein the cooking grate (140) and the electric heater (250) of the heating module (230) are integrally connected to each other.

15. The self-service take-out cooking box (200) of claim 9, wherein the cooking grate (140) and the electric heater (250) of the heating module (230) are detachably connected to each other.

16. A meal preparation method that enables a customer to prepare a customized meal comprising the steps of:
providing a self-service take-out cooking box (100); wherein the self-service take-out cooking box (100) comprises a heating module (130) and at least one food container (150);
packaging at least one food item (10) in the food container(s) (150) of the self-service take-out cooking box (100);
transporting the self-service take-out cooking box (100) to the customer;
placing of the food item(s) (10) of the food container(s) (150) onto a cooking grate (140) of the heating module (130) by the customer; and
customized heating of the food item(s)(10) using the heating module (130) by the customer; thereby preparing a customized meal.

17. The meal preparation method of claim 16, wherein the food item (10) packaged in the food container(s) (150) is initially raw uncooked food.

18. The meal preparation method of claim 16, wherein the food item (10) packaged in the food container(s) (150) is a ready-to-eat meal.

19. The meal preparation method of claim 16 further comprising a step of placing at least one cooking fuel (162) inside a cooking fuel receiving chamber (160) of the heating module (130); and igniting the cooking fuel(s) (162) to produce heat for the food item(s) (10).

20. The self-service take-out cooking box (100) of claim 16 further comprising a step of detaching the cooking grate (140) to allow placement and/or removal of the cooking fuel (162) in/from the cooking fuel receiving chamber (160).
